(19) United States
(12) Patent Application Publication
(10) Pub. No.: US 2015/0150068 A1
(43) Pub. Date: May 28, 2015

(54) METHOD AND SYSTEM FOR CROSS-CHANNEL MEDIA ASSETS MANAGEMENT

(71) Applicant: MediaMind Technologies Ltd., Herzliya (IL)

(72) Inventors: Jonathan Schler, Petah Tikva (IL); Ariel Nishri, Givataim (IL)

(73) Assignee: MediaMind Technologies Ltd., Herzliya (IL)

(21) Appl. No.: 14/087,713

(22) Filed: Nov. 22, 2013

(51) Int. Cl. H04N 21/45; H04N 21/61; H04N 21/472; H04N 21/435

(52) U.S. Cl. CPC H04N 21/45; H04N 21/435; H04N 21/6175; H04N 21/6181; H04N 21/47202
USPC 725/116

(57) ABSTRACT

A method and system for delivering a media asset to a plurality of destinations across a plurality of different media channels are provided. The method includes determining that the media asset is uploaded to at least one content source node; determining that a media plan associated with the media asset is uploaded to the at least one content source node; analyzing the media plan to determine the plurality of destinations for the media asset, the plurality of destinations are served through at least two different media channels; for each of the plurality of destinations, determining at least one transcoding scheme corresponding to the destination of the plurality of destinations; for each of the plurality of destinations, transcoding the media asset into a format compliant with properties of the at least one transcoding scheme; and delivering each transcoded media asset to the corresponding destination of the at least one transcoding scheme.

### TECHNICAL FIELD

The invention relates to the delivery of advertisements in a plurality of delivery channels.

### BACKGROUND

The world of digital delivery of media assets to viewers has been rapidly progressing. Typical types of media assets include video clips, electronic games, and interactive content. A media asset may be part of an advertising campaign. The delivery process for such media assets, particularly those transmitted in a form of video, may entail use of a variety of delivery standards, video quality levels, and other parameters. In addition, there is a need to preferably provide relevant advertisements to such content, with some advertisements being directly associated within the media assets, and some advertisements pulled from sources containing advertisements waiting to be appropriately displayed.

Seamless delivery and management of media assets, sometimes including related advertisements, is a need that is served independently for each distribution channel. That is, systems for delivery and trafficking of an asset operate in the traditional broadcast television (TV) independently of the asset being served by systems in the world of on-line content delivery. The techniques used in traditional broadcast TV cannot be effectively used in the more modern multi-standard digital TV arena, Currently, only piecemeal solutions are available for efficient and seamless delivery of such media assets and, when necessary, relevant advertisements, to the arena of digital TV.

For example, a video asset can be prepared for TV broadcasting, but that same video asset cannot also be displayed or distributed to web-pages or even web-sites (such as YouTube®) that have capabilities for displaying video contents.

A prior art solution for media asset management is based on a central system which stores media assets in a database. The system allows users to upload, search, and classify assets stored in the database. The system also delivers the media assets to their destinations on individual channels such as a magazine publisher or a television station. However, conventional media asset management does not support the delivery of assets across different channels. For example, an advertising agency currently cannot manage assets in an asset management system and deliver those assets to web-site destinations in the same form as they would deliver to TV destinations.

Therefore, in recognition of the deficiencies of the prior art, it would be advantageous to overcome the lack of a solution for seamlessly serving assets and associated advertisements across a plurality of different advertising channels.

### SUMMARY

Certain embodiments disclosed herein include a method and system for delivering a media asset to a plurality of destinations across a plurality of different media channels. The method comprises determining that the media asset is uploaded to at least one content source node; determining that a media plan associated with the media asset is uploaded to the at least one content source node; analyzing the media plan to determine the plurality of destinations for the media asset, wherein the plurality of destinations are served through at least two different media channels; for each of the plurality of destinations, determining at least one transcoding scheme corresponding to the destination of the plurality of destinations; for each of the plurality of destinations, transcoding the media asset into a format compliant with properties of the at least one transcoding scheme; and delivering each transcoded media asset to the corresponding destination of the at least one transcoding scheme.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a network system utilized to described the various disclosed embodiments;

FIG. 2 is a schematic diagram of a media asset management system supporting delivery of assets and associated advertisements according to one embodiment; and

FIG. 3 is a flowchart describing a delivery method of assets and associated advertisements according to one embodiment.

### DETAILED DESCRIPTION

It is important to note that the embodiments disclosed are only examples of the many advantageous uses of the innovative technique herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

FIG. 1 is a schematic diagram of a network system 100 utilized to described the various disclosed embodiments. A delivery network 110 provides connectivity between different elements of system 100. The delivery network 110 may be an Internet protocol (IP) based network, which may include a local area network (LAN), a wide area network (WAN), a metro area network (MAN), the world wide web (WEB) also occasionally referred to as the Internet, as well as other kinds of delivery networks that enable the delivery of the assets, and any combination thereto, including wired and wireless portions.

Media assets are typically video content that may be delivered either uninterrupted or, if so required, with interruptions. Distributors of media assets may want to deliver video content with interruptions to, among other things, deliver messages such as advertisements within the content of the assets. The assets may be provided from one or more content sources (CS) nodes 130-1 through 130-n, where ‘n’ is an integer beginning with ‘1’. The nodes 130-1, 130-n are computing devices (e.g., servers, workstations, database systems, etc.) accessible by creative shops, post production houses, advertisers, creative agencies, media agencies, and so on. The media assets, and any necessary advertisements, may be uploaded to a content source node 130 under the control of a media asset management server 120. The content source nodes 130 may be geographically distributed in a network proximity to users uploading assets and/or destinations that should be served with the assets.

According to the disclosed embodiments, the server 120 is configured to support delivery of the media assets and any associated advertisements across a plurality of technologically-distinct media channels. Such media channels include, but are not limited to, TV stations, radio stations, online-advertisement platforms, electronic billboards, Internet Kiosks, and the like. The TV station may include, for example, a cable TV station, a network TV station, an IPTV, a connected device (OTT), and so on. Examples of online-advertisement platforms include, but are not limited to, web-sites, social media networks, Internet video-on-demand services (e.g., Netflix®, Hulu®, etc.), video-sharing websites (e.g., YouTube®), and the like. The video assets may be displayed as an “on-screen” clip, as part of an ad-banner, and in other ways. It should be noted that media assets delivered to online-advertisement platforms should meet the properties of the destination device; that is, a media asset delivered to a video-on-demand service would be displayed differently on a smartphone than it would be displayed on a desktop.

The server 120 is communicatively connected to a transcoding specification database (TSDB) 125. To this end, the server 120 is configured to transcode a source media asset to a format that would meet the destination channel and device. That is, the transcoding includes the transformation of an input file from one format to another. For example, a file in a Quicktime® MOV format is transcoded into a MPEG2 format.

In order to perform the transcoding, the server 120 utilizes at least one transcoding engine (TXCE) 150. In an embodiment, the TXCE 150 can be communicatively connected to the server 120 either directly or through the network 110, or embedded in the server 120.

According to an embodiment, when uploading an asset onto a content source node 130, the asset is transcoded with respect to a transcoding scheme specification stored in the TSDB 125. Determination of the appropriate transcoding scheme corresponding to the media asset is conducted based on a media plan that is associated with the asset. The media plan typically entails media channels, media types, and destinations (DST) for each asset used in the campaign. The media plan also lists the time period and cost for serving the asset. An exemplary and non-limiting media plan is provided in Table 1.

TABLE 1

| Asset | Media Type | Media Channel | Destination |
|---|---|---|---|
| product A | Video | TV Broadcast | Cable Station 1 |
| (Video) | H.264. format | | |
| product A | Video | TV Broadcast | Cable Station 2 |
| (Video) | H.264. format | | |
| product A | Video | TV Broadcast | Network Station NBC |
| (Video) | MPEG4 | | |
| product A | Video | TV Broadcast | Local Network Station |
| (Video) | MPEG4 | | |
| product A | Audio | Radio Broadcast | Local Radio Station |
| (Audio) | .MP3 format | | |
| product A | Audio | Radio Broadcast | National Radio Station |
| (Audio) | .WAV format | | |
| product A | Interactive | Internet (on-line) | (Web-Site) CNN.com |
| (Video) | .MOV format | | |
| product A | Interactive | Internet (on-line) | Video-on-demand |
| (Video) | .MPEG4 format | | (Netflix) |
| product A | Interactive | Internet (on-line) | Video Sharing web- |
| (Video) | .AVI format | | site (You Tube) |
| product A | Image JPEG | Outdoor display | Electronic Billboard |
| (Image) | format | | at the mall |
| product A | Image | Outdoor display | Electronic Billboard |
| (Image) | JPEG2000 | | at a train station |
| | format | | |

In an embodiment, the media asset is a video asset that is being delivered across the different media channels to the various DST 140-1 through DST 140-n. The video asset is transcoded to a file format supported by the various destinations defined in the media plan. As shown in the exemplary Table 1, a media asset of a product A (e.g., a BMW® car) is transcoded to various media types such as video, audio, an interactive ad-banner, and an image. The specific format for a DST 140 is defined in a transcoding scheme specification. In an embodiment, the media asset is a multimedia file (such as video, audio, an image, a rich media, etc.). As shown in Table 1, a video asset for product A is transcoded to various types of video formats, an audio asset for product A is transcoded to various audio formats (e.g., MP3 and WAV), and an image asset for product A is transcoded to various image formats (e.g., JPEG and JPEG 2000).

In an embodiment, the transcoding scheme specification entails one or more of the format parameters for each DST, such as an image size, a bit rate, a video codec type, an audio file type, and so on. For example, the destination ‘Local Network Station’ may support a video file with a bit rate of 8,000 Kbps and a video codec of type H.264. The audio asset is transcoded to a MP3 audio format to be uploaded to a ‘Local Radio Station’ destination. To comply with the format ‘Video Sharing web-site’, the video asset is separately transcoded into a bit rate of 1,200 Kbps. In addition, the image size (i.e., image resolution or frame size) may need to be altered to fit the variety of locations for static images and video clips. For example, a billboard at a mall may call for an image size that is different than that of a billboard at a train station, thereby requiring further size and/or resolution transcoding. As another example, one web-site requires a video clip to be displayed a frame size of 640×480 pixels, while another web-site requires the frame size of the same clip to be 340×240 pixels. Thus, multiple different image (frame) sizes can be defined for the same video asset per DST.

In an embodiment, multiple variants of the same asset are delivered to a DST 140. Thus, multiple transcoding schemes can be defined for each destination. As an example, an asset delivered to YouTube® may be transcoded into .AVI, .MPEG, and .MOV formats. The variants can be determined based on the user device consuming information from a DST 140. As an example, a DST 140 may include transcoding schemes for smart phones and tablet computers operating using iOS® and Android® as well as for desktop computers.

In another embodiment, the transcoding schema of a DST 140 is determined respective of the properties of the uploaded video asset. For example, if the source video asset is High Definition (HD), a different transcoding schema is defined than would be for a standard definition video asset. In yet another embodiment, the transcoding scheme of a DST 140 is defined by the form of delivery of the transcoded assets. That is, for example, the definition of the transcoding scheme may depend on whether the assets should be packaged and/or delivered together with accompanying banners, metadata, images, and video files.

In another exemplary embodiment, a video asset (e.g., a video file) can be converted to an audio asset and/or an image asset, and then each asset is transcoded according to the transcoding scheme.

A DST 140 shown in FIG. 1 represents an electronic system configured to receive and process the transcoded assets delivered by the asset management server 120. A DST 140 is a system node including, but not limited to, a display terminal, a TV set-top box, a TV distribution system for broadcast of the assets to a plurality of nodes connected thereto, an audio server, a content delivery network (CDN) server, a web server, an application server, and the like. A DST 140 may operate in a pull state, i.e., pulling transcoded assets saved in a content source node 130, or operate in a push state, i.e., one or more assets are delivered to the DST 140 without receiving a request for such delivery.

The media asset management system 120 is further configured to allow users to search, classify, upload, and manage assets in the content source node 130. The management of such assets is operated via a centralized system 120 so as to deliver the assets to the various destinations of the different media channels according to the media plan. Accordingly, the disclosed embodiments allow users to upload an asset (or group of assets) prepared for a specific media channel and deliver the asset on different media channels without requiring that the user modify or revise the asset.

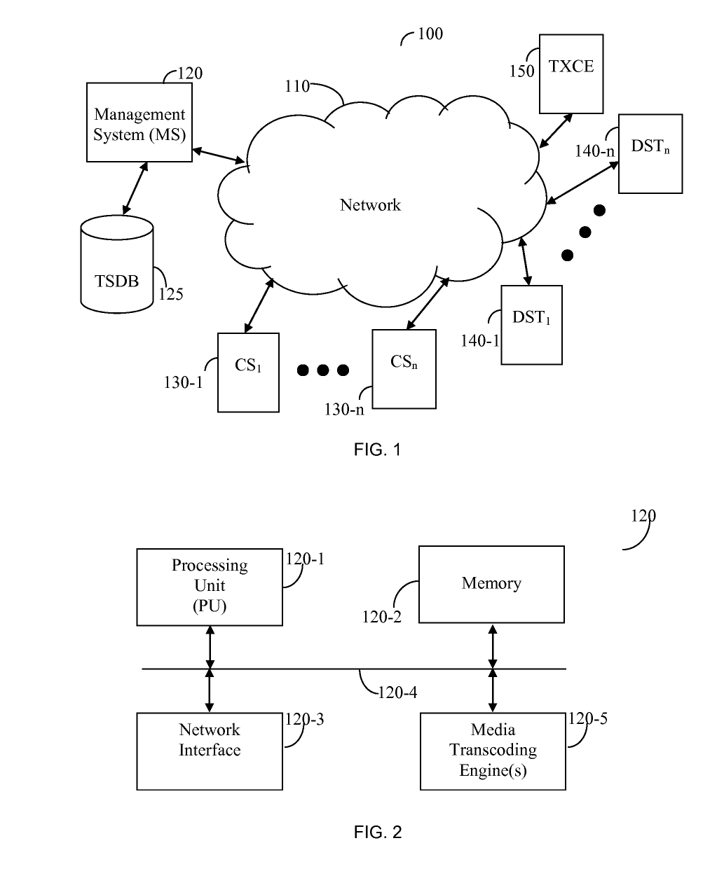

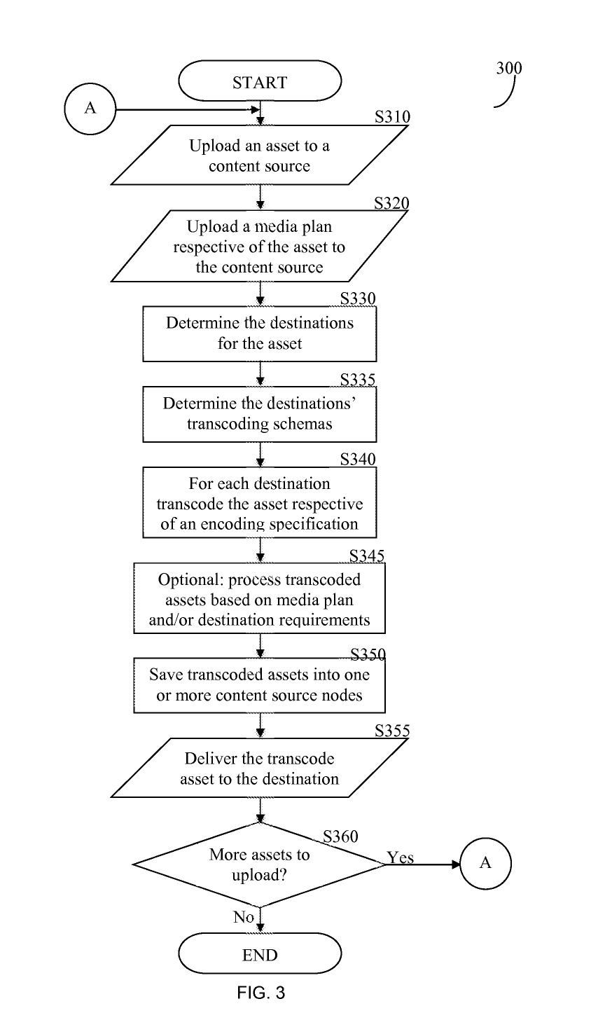

FIG. 2 shows an exemplary and non-limiting schematic block diagram of the media asset management system 120 according to one embodiment. A processing unit 120-1 comprising one or more processors is communicatively connected to a memory 120-2 via a bus 120-4. The memory 120-2 may comprise volatile and/or non-volatile memory components, including but not limited to the likes of static random access memory (SRAM), dynamic random access memory (SRAM), Flash memory, magnetic memory, and other tangible media on which data and/or instructions may be stored. Such instructions may include the method described in greater detail with respect to FIG. 3.

Further connected to the bus 120-4 is a network interface 120-3 allowing for bidirectional communication to and from the server 120. The memory 120-2 may contain instructions that, when executed by the processing unit 120-1, perform, for example and without limitations, the upload and delivery of assets as described herein.

In one embodiment, the media asset management system 120 includes a plurality of transcoding engines 120-5. Each such engine 120-5 is configured to transcode an audio/video/image file to a predetermined audio/video/image format. Examples for such formats supported by the transcoding engines include, but are not limited to, MP3, MPEG-4, H.264, .MOV, .WAV, .AVI, .JPEG, .JPEG2000, and so on. The transcoding may be performed using the video and audio transcoding techniques and standards discussed herein. The selection of which transcoding engine 120-5 to process an input file (asset) is made based on the transcoding scheme saved in the TSDB respective of each destination determined for the asset. As noted above, the server 120 under the control of the processing unit 120-1 can further process the transcoded file for the purpose of including images, banners, compression, and so on. Transcoding may further include transcoding of resolution, size, and other types of transcoding that change characteristics of the source media asset into a target media asset having at least one different characteristic.

FIG. 3 depicts an exemplary and non-limiting flowchart 300 describing the operation of a method for delivery of assets and associated advertisements across a plurality of media channels according to one embodiment. In an embodiment, the method is performed in part by the media asset management server 120.

In S310, an asset is uploaded to a content source node. In S320, a media plan associated with the uploaded asset is also uploaded to either a content source node or to the server. As discussed above, the media plan typically entails media channels, media types, and destinations for each asset used in the campaign. The media plan also typically lists the time period and cost for serving the asset. The uploaded asset may be any one of a video asset, an image asset, and an audio asset, and an interactive banner.

In S330, the media plan is processed to determine at least the destinations and their respective media type and channels for the uploaded asset. As noted above, the asset may be a video asset (e.g., a video file) that should be delivered to TV stations, radio stations, web sites and services, and so on. Thus, at least the destinations for the asset must be determined in order to properly deliver the asset.

In S335, the TSDB is queried to determine the transcoding schema for each destination. The transcoding schema defines, in part, one or more audio/video/image file formats, bit rates, resolutions, and so on, as required by the respective destination.

In S340, for each destination the asset is transcoded according to its respective transcoding scheme. The transcoding is performed by a transcoding engine configured to the conversion of the asset (e.g., an audio/video file) to the format defined in the scheme.

Optionally, at S345, the transcoded assets are further processed according to a set of requirements either determined by the destinations or defined in the media plan. This includes, but is not limited to, adding metadata, images, banners, and/or interactive layer to a transcoded asset. S345 may further include compression of a transcoded asset.

In S350, the transcoded assets are saved in one or more content sources (e.g., content source nodes 130). In an embodiment, an optimization process is performed to determine which of content source nodes the transcoded assets should be saved in. The determination may be based on the destinations that the assets should be delivered to. The optimization procedure takes into consideration factors such as the geographic location of a content source node with respect to a destination, a bandwidth of a content source node, the capacity of a network link to/from the content source node, and a monetary cost for serving the asset from a specific content source node. The optimization process aims to reduce latency and/or monetary cost to deliver a transcoded asset from a content source node to a destination.

In S355, the transcoded assets in the one or more content source nodes are delivered to their respective destinations, each destination receiving the asset properly transcoded. In one embodiment, the timing of delivery is set according to the time that the asset should be displayed or broadcasted as defined in the media plan. The delivery from a content source node to a destination can be performed using a file transfer protocol (FTP), a secured FTP, or any other means for file delivery. In S360, the system checks whether additional assets are to be uploaded and, if so, execution continues with S310; otherwise, execution terminates.

With respect of FIG. 3, while only the upload of assets is explicitly discussed above, additional associated content such as one or more video advertisements may also be uploaded, according to, for example, the media plan. The media plan itself may be, but is not limited to, a text file containing information respective of the destination 140 to which an asset is to be delivered, the advertisements that should be inserted respective of the asset, and other meta data, for example and without limitations, metadata respective of appropriate advertisements for the asset that a destination or content source node may associate with the asset.

In another embodiment, assets are uploaded to the media asset management server 120 and then searched and identified. This is performed in order to determine which advertisements will be attached to the asset for future placement. Then, the assets are transcoded to specification as provided by a TSDB 125, delivered to the content source node or destination where the asset and one or more associated advertisements are served. In yet another embodiment, the transcoding specifications are provided by a destination rather than from the TSDB 125.

The following is a non-limiting example for utilizing the media asset management server 120. A television commercial filmed to be displayed during a Super Bowl game is uploaded to a content source node. The agency running the campaign for the advertised product wishes to advertise the product through other media channels. Thus, a media plan is defined to designate the media channels and additional destinations for the commercial (in this instance, Hulu®, YouTube®, and radio stations are selected). The media plan is uploaded to the content source node for processing by the management server. Then, the uploaded commercial (video asset) is transcoded once per destination to meet each of the formats supported by the respective destinations. For example, the filmed commercial is transcoded to a .MOV format to be delivered to YouTube®, to a MPEG format to be delivered to Hulu®. Thus, from a single video asset (commercial), various video-compatible destinations in different media platforms can be served without requiring the agency's teams to individually prepare different advertisements/commercials for each destination. It should be noted that an audio asset respective of the product advertised in the television commercial can be also uploaded and transcoded to different audio formats to be played in a local radio station or an Internet radio station.

The various embodiments disclosed herein can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform, such as an additional data storage unit and a printing unit. Furthermore, a non-transitory computer readable medium is any computer readable medium except for a transitory propagating signal.

While the disclosed embodiments have been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for delivering a media asset to a plurality of destinations across a plurality of different media channels, comprising:
determining that the media asset is uploaded to at least one content source node;
determining that a media plan associated with the media asset is uploaded to the at least one content source node;
analyzing the media plan to determine the plurality of destinations for the media asset, wherein the plurality of destinations are served through at least two different media channels;
for each of the plurality of destinations, determining at least one transcoding scheme corresponding to the destination of the plurality of destinations;
for each of the plurality of destinations, transcoding the media asset into a format compliant with properties of the at least one transcoding scheme; and
delivering each transcoded media asset to the corresponding destination of the at least one transcoding scheme.

2. The method of claim 1, wherein the media asset is any one of: a video asset, an audio asset, a rich media asset, and an image asset.

3. The method of claim 1, wherein the at least one transcoding scheme is further determined based on a user device consuming information from the destination.

4. The method of claim 1, wherein the transcoding scheme is further defined according to properties of the uploaded media asset.

5. The method of claim 1, further comprising:
saving each of the transcoded media assets in the at least one content source node.

6. The method of claim 5, further comprising:
determining which of the at least one content source node each transcoded media asset should be saved in based on the transcoded media asset's associated destination.

7. The method of claim 1, wherein the media plan further defines information regarding a form of delivery of the each transcoded asset, wherein the a form of delivery comprises at least one of: packaging of the assets and delivery of the assets with at least an accompanying file.

8. The method of claim 7, wherein the least an accompanying file includes at least one of: metadata, an image, a banner, and an interactive layer.

9. The method of claim 7, wherein the media asset accompanied by any one of: the interactive layer, the image, and the banner is an online advertisement.

10. The method of claim 1, wherein each of a plurality of different media channels includes at least: a TV station, a radio station, an online-advertisement platform, an electronic billboard, and an Internet kiosk.

11. The method of claim 1, wherein the online-advertisement platform includes at least any one of: a web-site, a social media network, an Internet video-on-demand service, an Internet radio station, and a video-sharing web-site.

12. A non-transitory computer readable medium having stored thereon instructions for causing one or more processing units to execute the method according to claim 1.

13. A system for delivering a media asset to a plurality of destinations across a plurality of different media channels, comprising:
a processor; and
a memory communicatively connected to the processor, the memory contains instructions that when executed by the processor, configured the system to:
determine that the media asset is uploaded to at least one content source node;
determine that a media plan associated with the media asset is uploaded to the at least one content source node;
analyze the media plan to determine the plurality of destinations for the media asset, wherein the plurality of destinations are served through at least two different media channels;
for each of the plurality of destinations, determine at least one transcoding scheme corresponding to the destination of the plurality of destinations;
for each of the plurality of destinations, transcode the media asset into a format compliant with properties of the at least one transcoding scheme; and
deliver each transcoded media asset to the corresponding destination of the at least one transcoding scheme.

14. The system of claim 13, wherein the media asset is any one of: a video asset, a rich media asset, an audio asset, and an image asset.

15. The system of claim 13, wherein the at least one transcoding scheme is further determined based on a user device consuming information from the destination.

16. The system of claim 13, wherein the transcoding scheme is further defined according to properties of the uploaded media asset.

17. The system of claim 13, wherein the system is further configured to save each of the transcoded media assets in the at least one content source node.

18. The system of claim 17, wherein the system is further configured to determine which of the at least one content source node each transcoded media asset should be saved in based on the transcoded media asset's associated destination.

19. The system of claim 18, wherein the media plan further defines information regarding a form of delivery of the each transcoded asset, wherein the a form of delivery comprises at least one of: packaging of the assets and delivery of the assets with at least an accompanying file.

20. The system of claim 19, wherein the least an accompanying file includes at least one of: metadata, an image, a banner, and an interactive layer.

21. The system of claim 19, wherein the media asset accompanied by any one of: the interactive layer, the image, and the banner is an online advertisement.

22. The system of claim 13, wherein each of a plurality of different media channels includes at least: a TV station, a radio station, an online-advertisement platform, an electronic billboard, and an Internet kiosk.

23. The system of claim 13, wherein the online-advertisement platform includes at least any one of: a web-site, a social media network, an Internet video-on-demand service, an Internet radio station, and a video-sharing web-site.
